(19) United States
(12) Patent Application Publication
(10) Pub. No.: US 2020/0157958 A1
(43) Pub. Date: May 21, 2020

(54) METHOD FOR MANUFACTURING NOZZLE DIAPHRAGM AND NOZZLE DIAPHRAGM

(71) Applicant: MITSUBISHI HEAVY INDUSTRIES COMPRESSOR CORPORATION, Tokyo (JP)

(72) Inventors: Shinji Takemoto, Hiroshima (JP); Masahiro Matsunaga, Hiroshima (JP)

(73) Assignee: MITSUBISHI HEAVY INDUSTRIES COMPRESSOR CORPORATION, Tokyo (JP)

(21) Appl. No.: 16/680,577

(22) Filed: Nov. 12, 2019

(30) Foreign Application Priority Data
Nov. 15, 2018 (JP) 2018-214624

(51) Int. Cl. F01D 9/04

(52) U.S. Cl. CPC F01D 9/044; F05D 2230/232; F05D 2220/31

(57) ABSTRACT

There is provided a method for manufacturing a nozzle diaphragm which can be assembled with high accuracy. The method for manufacturing a nozzle diaphragm includes a preparation step S1 of preparing an inner ring, a plurality of nozzles, an outer shroud ring, and an outer ring, a ring installation step S2 of installing the outer shroud ring, a nozzle installation step S3 of installing the nozzles while an outer peripheral end portion of a nozzle main body is inserted into a through-hole formed in the outer shroud ring, an inner ring installation step S4 of installing the inner ring, an outer ring installation step S5 of installing the outer ring outside the outer shroud ring, and a welding step S6 of welding the outer ring and the outer shroud ring to each other, and welding the inner ring and the inner shroud to each other in a circumferential direction.

### BACKGROUND

### Field

The present disclosure relates to a method for manufacturing a nozzle diaphragm and a nozzle diaphragm.

Priority is claimed on Japanese Patent Application No. 2018-214624, filed on Nov. 15, 2018, the content of which is incorporated herein by reference.

### Description of Related Art

A steam turbine mainly includes a rotor that is rotated around an axis, and a casing that covers the rotor from the outside and that forms a steam flow path between the rotor and the casing. The rotor has a rotary shaft that extending along the axis and a plurality of rotor blades arranged on an outer peripheral surface of the rotary shaft. An inner peripheral surface of the casing is provided with a nozzle diaphragm having a plurality of stator blades (nozzles) arranged to be alternate with the plurality of rotor blades in an axial direction.

As a specific example of the nozzle diaphragm, a nozzle diaphragm disclosed in Japanese Unexamined Patent Application, First Publication No. H9-53410 is known. The nozzle diaphragm disclosed in Japanese Unexamined Patent Application, First Publication No. H9-53410 has a nozzle ring, an inner ring installed on an inner peripheral side of the nozzle ring, and an outer ring installed on an outer peripheral side of the nozzle ring. The nozzle ring has a plurality of nozzle plates having an airfoil cross section, the inner ring backing plate installed on an inner peripheral side of the nozzle plate, and an outer ring backing plate installed on an outer peripheral side of the nozzle plate. The inner ring backing plate and the outer ring backing plate have holes having a shape that follows a cross-sectional shape of the nozzle plate. In a state where the nozzle plate is inserted into the hole, the inner ring backing plate and the outer ring backing plate are respectively and separately welded to the nozzle plate. In this manner, the nozzle ring is formed. Thereafter, the nozzle ring is fitted between the inner ring and the outer ring, and the nozzle diaphragm is formed by separately welding groove portions to each other.

### SUMMARY

Incidentally, when the nozzle diaphragm is manufactured, a plurality of members need to be separately welded to each other at a plurality of locations. Consequently, the individual members may be incorrectly aligned with each other when welded. As a result, in some cases, a posture of the nozzle plate relative to the inner ring backing plate and the outer ring backing plate may not be uniform in a circumferential direction. For this reason, a throat or a pitch serving as a factor for determining performance of the steam turbine inevitably varies in the plurality of nozzles. Therefore, there is a demand to assemble the nozzle diaphragm with higher accuracy.

According to the present disclosure, there is provided a method for manufacturing a nozzle diaphragm and a nozzle diaphragm which can be assembled with high accuracy.

According to a first aspect of the present disclosure, there is provided a method for manufacturing a nozzle diaphragm. The method includes a preparation step of preparing an inner ring having an annular shape, a plurality of nozzles each having an inner shroud which comes into contact with an outer peripheral surface of the inner ring, and a nozzle main body having an integral structure which protrudes outward from the inner shroud in a radial direction, an outer shroud ring having a plurality of through-holes penetrating in the radial direction with a size which enables each outer peripheral end portion of the nozzle main bodies to be inserted into each of the plurality of through-holes, and an outer ring having an annular shape to be installed on an outer peripheral side with respect to the outer shroud ring, a ring installation step of installing the outer shroud ring, a nozzle installation step of installing the plurality of nozzles so that the inner shrouds are aligned, while inserting the outer peripheral end portion into each of the plurality of through-holes formed in the outer shroud ring, after the ring installation step, an inner ring installation step of annularly installing the inner ring so that the outer peripheral surface of the inner ring is installed along the inner shroud, after the nozzle installation step, an outer ring installation step of installing the outer ring outside the outer shroud ring, after the inner ring installation step, and a welding step of welding the outer ring and the outer shroud ring to each other, and welding the inner ring and the inner shroud to each other in the circumferential direction.

According to the above-described method, in the nozzle installation step, the nozzle is installed while the outer peripheral end portion of the nozzle main body is inserted into the through-hole formed in the outer shroud ring. Here, the outer peripheral end portion of the nozzle main body is attached to the through-hole by means of clearance-fitting. Therefore, in the nozzle installation step, even in a state where the outer peripheral end portion is inserted into the through-hole, a posture of the nozzle can be slightly adjusted. In a state where the posture is adjusted, a subsequent welding step is performed. Accordingly, it is possible to form the nozzle diaphragm in which each nozzle is located at a correct position and adopts a correct posture.

In the method for manufacturing a nozzle diaphragm according to a second aspect of the present disclosure, in the welding step, the welding may also be performed in a region between the outer ring and the outer peripheral end portion inside each of the plurality of through-holes.

According to the above-described method, in the welding step, in addition to the region between the outer ring and the outer shroud ring, the welding is also performed in the region between the outer peripheral end portion of the nozzle main body and the outer ring. Therefore, the nozzle main body supported inside the through-hole by means of clearance-fitting can be fixed to the outer ring. In this manner, it is possible to form the nozzle diaphragm in which each nozzle is located at a correct position and adopts a correct posture.

In the method for manufacturing a nozzle diaphragm according to a third aspect of the present disclosure, in the outer ring installation step, the outer ring may be fixed to the outer shroud ring by means of shrink-fitting.

According to a fourth aspect of the present disclosure, there is provided a nozzle diaphragm including an inner ring having an annular shape, a plurality of nozzles disposed in a circumferential direction, and each having an inner shroud which comes into contact with an outer peripheral surface of the inner ring, and a nozzle main body having an integral structure which protrudes outward from the inner shroud in a radial direction, an outer shroud ring having a plurality of through-holes penetrating in the radial direction so that each outer peripheral end portion of the nozzle main bodies is inserted into each of the plurality of through-holes, an outer ring having an annular shape, and attached to an outer peripheral surface of the outer shroud ring by means of interference-fitting, an inner welded portion formed between the inner ring and the inner shrouds so as to join the inner ring and the inner shrouds to each other, and an outer welded portion formed between the outer ring and the outer shroud ring so as to join the outer ring and the outer shroud ring to each other.

In the nozzle diaphragm according to a fifth aspect of the present disclosure, the outer welded portion may extend to between the outer ring and the outer peripheral end portion inside each of the plurality of through-holes.

According to a sixth aspect of the present disclosure, there is provided a method for manufacturing a nozzle diaphragm. The method includes a preparation step of preparing an outer ring having an annular shape, a plurality of nozzles each having an outer shroud which comes into contact with an inner peripheral surface of the outer ring, and a nozzle main body having an integral structure which protrudes inward from the outer shroud in a radial direction, an inner shroud ring having a plurality of through-holes penetrating in the radial direction with a size which enables each inner peripheral end portion of the nozzle main bodies to be inserted into each of the plurality of through-holes, and an inner ring having an annular shape to be installed on an outer peripheral side with respect to the inner shroud ring, a ring installation step of installing the inner shroud ring, a nozzle installation step of installing the plurality of nozzles so that the outer shrouds are aligned, while inserting the inner peripheral end portion into the each of the plurality of through-holes formed in the inner shroud ring, after the ring installation step, an outer ring installation step of annularly installing the outer ring so that the inner peripheral surface of the outer ring is installed along the outer shroud, after the nozzle installation step, an inner ring installation step of installing the inner ring inside the inner shroud ring after the outer ring installation step, and a welding step of welding the inner ring and the inner shroud ring to each other, and welding the outer ring and the outer shroud to each other in the circumferential direction.

According to the above-described method, in the nozzle installation step, the nozzle is installed while the inner peripheral end portion of the nozzle main body is inserted into the through-hole formed in the inner shroud ring. Here, the inner peripheral end portion of the nozzle main body is attached to the through-hole by means of clearance-fitting. Therefore, in the nozzle installation step, even in a state where the inner peripheral end portion is inserted into the through-hole, a posture of the nozzle can be slightly adjusted. In a state where the posture is adjusted, a subsequent welding step is performed. Accordingly, it is possible to form the nozzle diaphragm in which each nozzle is located at a correct position and adopts a correct posture.

In the method for manufacturing a nozzle diaphragm according to a seventh aspect of the present disclosure, in the welding step, the welding may also be performed in a region between the inner ring and the inner peripheral end portion inside each of the plurality of through-holes.

According to the above-described method, in the welding step, in addition to the region between the inner ring and the inner shroud ring, the welding is also performed in the region between the inner peripheral end portion of the nozzle main body and the inner ring. Therefore, the nozzle main body supported inside the through-hole by means of clearance-fitting can firmly be fixed to the inner ring. In this manner, it is possible to form the nozzle diaphragm in which each nozzle is located at a correct position and adopts a correct posture.

In the method for manufacturing a nozzle diaphragm according to an eighth aspect of the present disclosure, in the inner ring installation step, the inner ring may be fixed to the inner shroud ring by means of cold-fitting.

According to a ninth aspect of the present disclosure, there is provided a nozzle diaphragm including an outer ring having an annular shape, a plurality of nozzles disposed in a circumferential direction, and each having an outer shroud which comes into contact with an inner peripheral surface of the outer ring, and a nozzle main body having an integral structure which protrudes inward from the outer shroud in a radial direction, an inner shroud ring having a plurality of through-holes penetrating in the radial direction so that each inner peripheral end portion of the nozzle main bodies is inserted into each of the plurality of through-holes, an inner ring having an annular shape, and attached to an inner peripheral surface of the inner shroud ring by means of interference-fitting, an outer welded portion formed between the outer ring and the outer shrouds so as to join the outer ring and the outer shrouds to each other, and an inner welded portion formed between the inner ring and the inner shroud ring so as to join the inner ring and the inner shroud ring to each other.

In the nozzle diaphragm according to a tenth aspect of the present disclosure, the inner welded portion may extend to between the inner ring and the inner peripheral end portion inside each of the plurality of through-holes.

According to the present disclosure, it is possible to provide the method for manufacturing the nozzle diaphragm and the nozzle diaphragm which can be assembled with high accuracy.

### BRIEF DESCRIPTION OF THE DRAWINGS

FIG. 1 is a view showing a configuration of a nozzle diaphragm according to a first embodiment of the present disclosure, and is a sectional view in a plane orthogonal to an axis.

FIG. 2 is a view showing a configuration of the nozzle diaphragm according to the first embodiment of the present disclosure, and is a sectional view in a plane including the axis.

FIG. 3 is a flowchart showing a method for manufacturing the nozzle diaphragm according to the first embodiment of the present disclosure.

FIG. 4 is a view showing a configuration of a nozzle diaphragm according to a second embodiment of the present disclosure, and is a sectional view in a plane orthogonal to an axis.

FIG. 5 is a view showing a configuration of the nozzle diaphragm according to the second embodiment of the present disclosure, and is a sectional view in a plane including the axis.

FIG. 6 is a flowchart showing a method for manufacturing the nozzle diaphragm according to the second embodiment of the present disclosure.

### DETAILED DESCRIPTION OF THE INVENTION

### First Embodiment

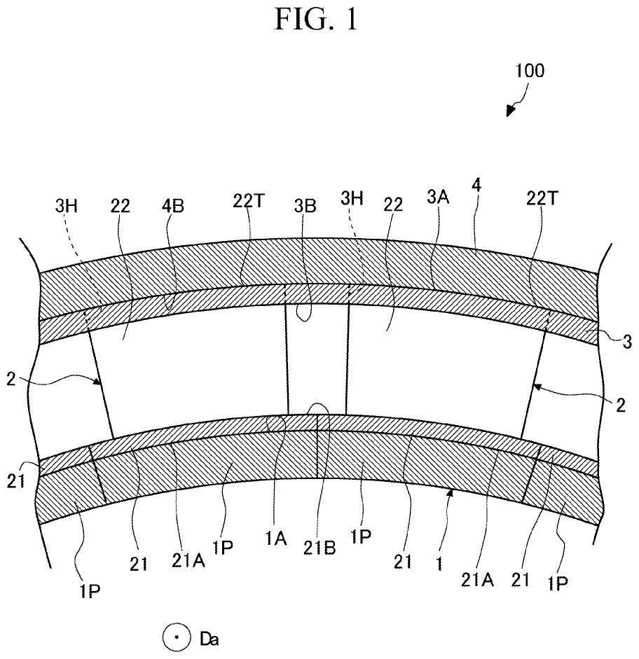

A first embodiment according to the present disclosure will be described with reference to FIGS. 1 to 3. A nozzle diaphragm 100 according to the present embodiment is installed to be exposed in a steam flow path of a steam turbine, for example. In this manner, the nozzle diaphragm 100 is used for rectifying and guiding a steam flow directed toward a turbine rotor blade. The nozzle diaphragm 100 has an annular shape formed around an axis of the steam turbine.

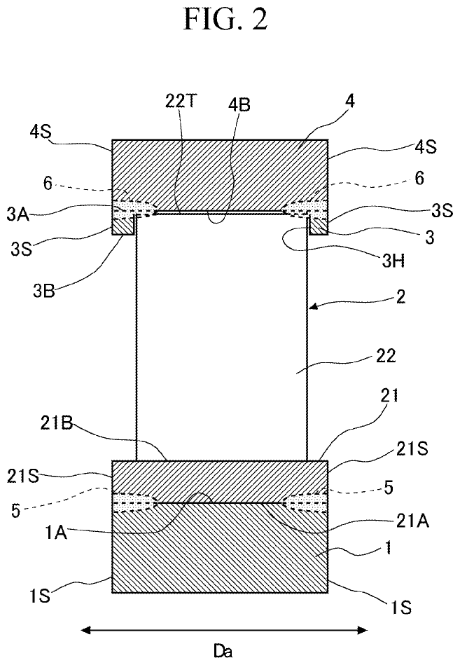

In FIGS. 1 and 2, a direction parallel to the axis of the steam turbine is shown as an “axial direction Da”. That is, in FIG. 1, the axial direction Da is a direction perpendicular to the paper surface, and in FIG. 2, the axial direction Da is a direction parallel to the paper surface. In the following description, a radial direction and a circumferential direction based on the above-described axis will simply be referred to as a “radial direction” and a “circumferential direction”.

As shown in FIG. 1 or 2, the nozzle diaphragm 100 includes an inner ring 1, a nozzle 2, an outer shroud ring 3, an outer ring 4, and an inner welded portion 5 (refer to FIG. 2), and an outer welded portion 6 (refer to FIG. 2).

The inner ring 1 has a plurality of inner ring pieces 1P arranged in the circumferential direction. Each of the inner ring pieces 1P has an arc shape extending in the circumferential direction. A pair of the inner ring pieces 1P adjacent to each other is in contact with each other without any clearance in the circumferential direction. The inner ring pieces 1P are aligned with and joined to each other in the circumferential direction, thereby forming an annular shape of the inner ring 1. The inner ring pieces 1P are connected to each other by means of electronic beam welding (EBW). The nozzle 2 is attached to a surface (inner ring outer peripheral surface 1A) that faces outward in the radial direction in the inner ring 1.

A plurality of the nozzles 2 are provided corresponding to each of the inner ring pieces 1P. That is, the number of the inner ring pieces 1P and the number of the nozzles 2 are the same as each other. Each of the nozzles 2 has an inner shroud 21 and a nozzle main body 22. The inner shroud 21 and the nozzle main body 22 have an integral structure. The inner shroud 21 has a plate shape spreading along the inner ring outer peripheral surface 1A. An inner peripheral surface (inner shroud inner peripheral surface 21A) of the inner shroud 21 and the inner ring outer peripheral surface 1A are in contact with each other without any clearance in the radial direction. That is, a curvature of the inner shroud inner peripheral surface 21A and a curvature of the inner ring outer peripheral surface 1A are the same as each other. The nozzle main body 22 extends from above the outer peripheral surface (inner shroud outer peripheral surface 21B) of the inner shroud 21.

The nozzle main body 22 is a member for forming a flow path through which steam flows when high-temperature and high-pressure steam is guided and rectified toward a turbine rotor blade during an operation of a steam turbine. The nozzle main body 22 extends outward in the radial direction from the inner shroud outer peripheral surface 21B. Although not shown in detail, a cross-sectional shape (cross-sectional shape in the radial direction) of the nozzle main body 22 is an airfoil shape in which a steam inflow side (upstream side) is set as a leading edge and a steam outflow side (downstream side) is set as a trailing back edge. A dimension of the nozzle main body 22 in the radial direction is set to be larger than each dimension of the inner ring 1 and the outer ring 4 in the radial direction. An outer end portion (outer peripheral end portion 22T) of the nozzle main body 22 in the radial direction is joined to the outer shroud ring 3 and the outer ring 4.

The outer shroud ring 3 has the annular shape that is concentric with the inner ring 1 and the inner shroud 21. The outer shroud ring 3 is integrally formed as one member. The outer shroud ring 3 has a plurality of through-holes 3H into which the outer peripheral end portion 22T of the nozzle main body 22 can be inserted. As shown in FIG. 2, the through-hole 3H penetrates the outer shroud ring 3 in the radial direction. Although not shown in detail, an opening shape of the through-hole 3H corresponds to the outer peripheral end portion 22T of the nozzle main body 22. That is, the through-hole 3H also has an airfoil shape when viewed in the radial direction in accordance with the outer peripheral end portion 22T having an airfoil shape. The dimension of the through-hole 3H is set to be slightly larger than the dimension of the outer peripheral end portion 22T. That is, in a state where the outer peripheral end portion 22T is inserted into the through-hole 3H, a slight clearance is formed between the nozzle main body 22 and an inner surface of the through-hole 3H. In other words, the outer peripheral end portion 22T is attached to the through-hole 3H by means of clearance-fitting.

The outer ring 4 is in contact with an outer peripheral surface (outer shroud ring outer peripheral surface 3A) of the outer shroud ring 3. The outer ring 4 has an annular shape that is concentric with the inner ring 1, the inner shroud 21, and the outer shroud ring 3. The outer ring 4 is integrally formed using a single member. As shown in FIG. 2, an inner peripheral surface (outer ring inner peripheral surface 4B) of the outer ring 4 is in contact with the outer shroud ring outer peripheral surface 3A in a state where both of these are flush with each other. The outer ring inner peripheral surface 4B is installed in a state where a slight clearance is formed with the outer peripheral end portion 22T of the nozzle main body 22. Although details will be described later, the outer ring 4 is fixed to the outer shroud ring 3 by means of interference-fitting.

The dimension (thickness) of the outer shroud ring 3 in the radial direction is set so that the outer shroud ring 3 can be bent. The dimension of the outer shroud ring 3 in the radial direction indicates the dimension in the radial direction from the outer shroud ring outer peripheral surface 3A to an inner peripheral surface (outer shroud ring inner peripheral surface 3B) of the outer shroud ring 3.

As shown by a broken line in FIG. 2, the inner welded portion 5 is formed between the inner ring 1 and the inner shroud 21. The inner welded portion 5 is formed in a boundary between an end surface (inner ring end surface 1S) of the inner ring 1 facing the axial direction Da and an end surface (inner shroud end surface 21S) of the inner shroud 21 facing the axial direction Da. The inner welded portion 5 is continuously formed in the circumferential direction. Furthermore, the inner welded portion 5 spreads inward in the axial direction Da of the inner ring end surface 1S and the inner shroud end surface 21S from the boundary. That is, the inner welded portion 5 joins the inner ring 1 and the inner shroud 21 to each other. The inner welded portion 5 is formed by means of electronic beam welding.

As similarly shown by a broken line in FIG. 2, the outer welded portion 6 is formed between the outer ring 4 and the outer shroud ring 3, and between the outer ring 4 and the nozzle main body 22 (outer peripheral end portion 22T). The outer welded portion 6 is formed in a boundary between an end surface (outer ring end surface 4S) of the outer ring 4 facing the axial direction Da and an end surface (outer shroud ring end surface 3S) of the outer shroud ring 3 facing the axial direction Da. The outer welded portion 6 is continuously formed in the circumferential direction. Furthermore, the outer welded portion 6 spreads inward in the axial direction Da of the outer ring end surface 4S and the outer shroud ring end surface 3S from the boundary. In particular, the outer welded portion 6 reaches a region between the outer ring inner peripheral surface 4B and the outer peripheral end portion 22T of the nozzle main body 22 (that is, a region where the outer ring inner peripheral surface 4B inside the through-hole 3H and the outer peripheral end portion 22T face each other). That is, the outer welded portion 6 simultaneously joins the outer ring 4, the outer shroud ring 3, and the nozzle main body 22. The outer welded portion 6 is formed by means of electronic beam welding, similarly to the inner welded portion 5. The “welded portion” in the inner welded portion 5 and the outer welded portion 6 indicates a portion where a ground melted by the electronic beam welding is cooled and hardened.

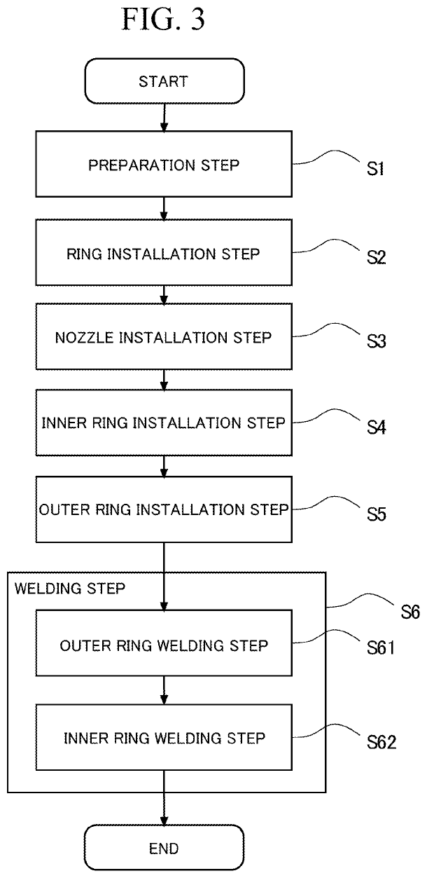

Next, a method for manufacturing the nozzle diaphragm 100 according to the present embodiment will be described with reference to FIG. 3. As shown in the drawing, the manufacturing method includes a preparation step S1, a ring installation step S2, a nozzle installation step S3, an inner ring installation step S4, an outer ring installation step S5, and a welding step S6.

In the preparation step S1, the inner ring 1, the nozzle 2, the outer shroud ring 3, and the outer ring 4 are prepared. In obtaining these components, a method appropriately selected from various processing methods such as casting, forging, and cutting is used.

After the preparation step S1, the ring installation step S2 is performed. In the ring installation step S2, the outer shroud ring 3 is installed on a surface plate so as to form an annular shape. It is desirable that the respective steps subsequent to the ring installation step S2 are performed on the surface plate subjected to leveling and flattening.

After the ring installation step S2, the nozzle installation step S3 is performed. In the nozzle installation step S3, while the outer peripheral end portion 22T of the nozzle main body 22 is inserted into the through-hole 3H of the outer shroud ring 3, the plurality of nozzles 2 are arranged so that the inner shrouds 21 are aligned with each other.

After the nozzle installation step S3, the inner ring installation step S4 is performed. In the inner ring installation step S4, the outer peripheral surface (inner ring outer peripheral surface 1A) of the inner ring 1 is installed along the inner shroud 21. Specifically, the inner ring pieces 1P are arranged in the circumferential direction in a state of being in contact with the inner ring outer peripheral surface 1A, and the adjacent inner ring pieces IP are joined to each other by means of welding. In this manner, the inner ring 1 having an annular shape is formed. Therefore, the inner ring 1 and the outer shroud ring 3 are installed to be concentric with each other on the surface plate. That is, the outer shroud ring 3 is brought into an installed state to surround the outer peripheral side of the inner ring 1.

After the inner ring installation step S4, the outer ring installation step S5 is performed. In the outer ring installation step S5, the outer ring 4 is attached to the outside of the outer shroud ring 3. More specifically, the outer ring 4 is attached to the outside of the outer shroud ring 3 by means of shrink-fitting. That is, prior to the outer ring installation step S5, the outer ring 4 is installed on the outside of the outer shroud ring 3 in a state where the outer ring 4 is heated and thermally expanded. Thereafter, the outer ring 4 is cooled and contracted, and the outer ring 4 is fixed to the outer shroud ring 3 and the outer peripheral end portion 22T of the nozzle main body 22.

After the outer ring installation step S5, the welding step S6 is performed. The welding step S6 includes an outer ring welding step S61 and an inner ring welding step S62. In the outer ring welding step S61, the outer welded portion 5 is formed by means of electronic beam welding. In the inner ring welding step S62, the inner welded portion 6 is formed by means of electronic beam welding. According to the above-described method, all steps of the method for manufacturing the nozzle diaphragm 100 according to the present embodiment are completed.

According to the above-described method and configuration, in the nozzle installation step S3, the nozzle 2 is installed while the outer peripheral end portion 22T of the nozzle main body 22 is inserted into the through-hole 3H formed in the outer shroud ring 3. Here, the outer peripheral end portion 22T of the nozzle main body 22 is attached to the through-hole 3H by means of clearance-fitting. Therefore, in the nozzle installation step S3, even in a state where the outer peripheral end portion 22T is inserted into the through-hole 3H, a posture of the nozzle 2 can be slightly adjusted. In a state where the posture is adjusted, the subsequent welding step S6 is performed. Accordingly, it is possible to form the nozzle diaphragm 100 in which each nozzle 2 is located at a correct position and adopts a correct posture.

Furthermore, in the welding step S6, in addition to a region between the outer ring 4 and the outer shroud ring 3, the welding is also performed in a region between the outer peripheral end portion 22T of the nozzle main body 22 and the outer ring 4 (that is, a region inside the through-hole 3H). Therefore, the nozzle main body 22 supported inside the through-hole 3H by means of clearance-fitting can be fixed to the outer ring 4. In this manner, it is possible to form the nozzle diaphragm 100 in which each nozzle 2 is located at a correct position and adopts a correct posture.

In addition, the outer ring 4 can be more firmly fixed to the outer shroud ring 3 by means of shrink-fitting. Furthermore, even in a case where the outer peripheral end portion 22T of the nozzle main body 22 protrudes outward in the radial direction from the through-hole 3H formed in the outer shroud ring 3, the outer ring 4 is subjected to the shrink-fitting. In this manner, the nozzles 2 can be more uniformly arranged.

### Second Embodiment

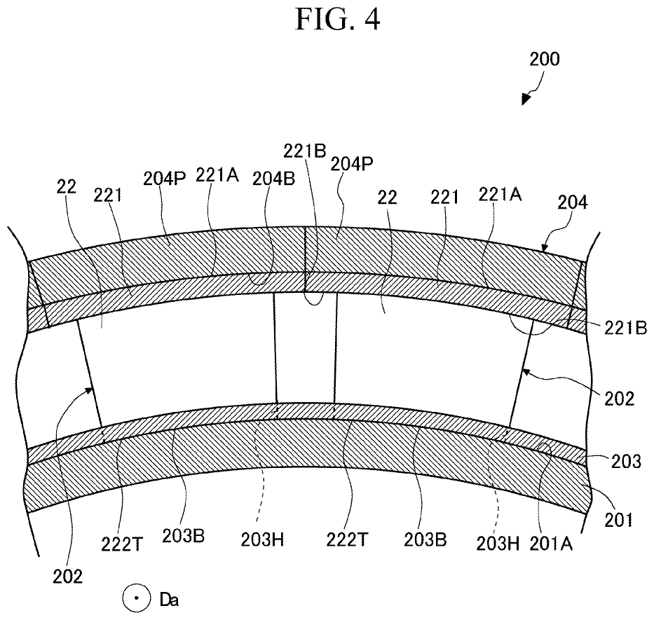

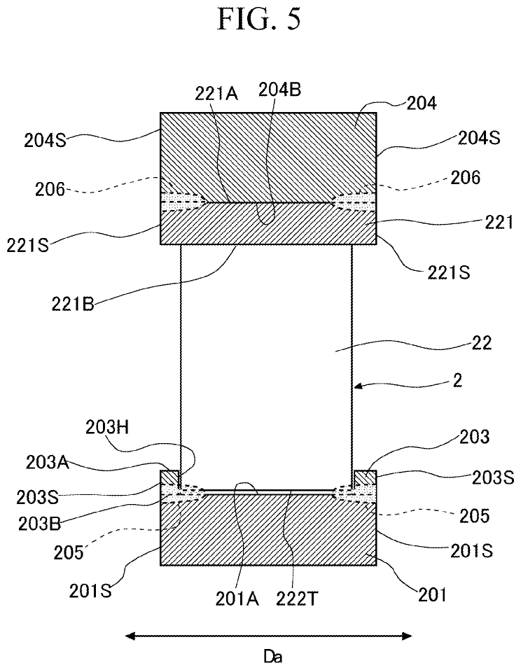

Next, a second embodiment according to the present disclosure will be described with reference to FIGS. 4 to 6. The same reference numerals will be given to configurations and steps which are the same as those according to the above-described first embodiment, and detailed description thereof will be omitted. A nozzle diaphragm 200 according to the present embodiment includes an outer ring 204, a nozzle 202, an inner shroud ring 203, an inner ring 201, an inner welded portion 205 (refer to FIG. 5), and an outer welded portion 206 (refer to FIG. 5).

The outer ring 204 has a plurality of outer ring pieces 204P arranged in the circumferential direction. Each of the outer ring pieces 204P has an arc shape extending in the circumferential direction. The pair of adjacent outer ring pieces 204P is in contact with each other without any clearance in the circumferential direction. The outer ring pieces 204P are arranged in the circumferential direction, and are joined to each other, thereby forming the outer ring 204 having an annular shape. In fixing the outer ring pieces 204P to each other, both of these are connected to each other by means of electronic beam welding (EBW). The nozzle 202 is attached to a surface (outer ring inner peripheral surface 204B) that faces inward in the radial direction of the outer ring 204.

A plurality of the nozzles 202 are provided corresponding to each of the outer ring pieces 204P. That is, the number of the outer ring pieces 204P and the number of the nozzles 202 are the same as each other. Each of the nozzles 202 has an outer shroud 221 and the nozzle main body 22. The outer shroud 221 and the nozzle main body 22 have an integral structure. The outer shroud 221 has a plate shape spreading along the outer ring inner peripheral surface 204B. An outer peripheral surface (outer shroud outer peripheral surface 221A) of the outer shroud 221 and the outer ring inner peripheral surface 204B are in contact with each other without any clearance in the radial direction. That is, a curvature of the outer shroud outer peripheral surface 221A and a curvature of the outer ring inner peripheral surface 204B are the same as each other. The nozzle main body 22 extends from above the inner peripheral surface (outer shroud inner peripheral surface 221B) of the outer shroud 221. An inner end portion (inner peripheral end portion 222T) of the nozzle main body 22 in the radial direction according to the second embodiment is joined to the inner shroud ring 203 and the inner ring 201.

The inner shroud ring 203 has an annular shape that is concentric with the outer ring 204 and the outer shroud 221. The inner shroud ring 203 is integrally formed as one member. The inner shroud ring 203 has a plurality of through-holes 203H into which the inner peripheral end portion 222T of the nozzle main body 22 can be inserted. As shown in FIG. 5, the through-hole 203H penetrates the inner shroud ring 203 in the radial direction. Although not shown in detail, an opening shape of the through-hole 203H corresponds to the inner peripheral end portion 222T of the nozzle main body 22. That is, the through-hole 203H also has an airfoil shape when viewed in the radial direction in accordance with the inner peripheral end portion 222T having an airfoil shape. The dimension of the through-hole 203H is set to be slightly larger than the dimension of the inner peripheral end portion 222T. That is, in a state where the inner peripheral end portion 222T is inserted into the through-hole 203H, a slight clearance is formed between the nozzle main body 22 and an inner surface of the through-hole 203H. In other words, the inner peripheral end portion 222T is attached to the through-hole 203H by means of clearance-fitting.

The inner ring 201 is in contact with an inner peripheral surface (inner shroud ring inner peripheral surface 203B) of the inner shroud ring 203. The inner ring 201 has an annular shape that is concentric with the outer ring 204, the outer shroud 221, and the inner shroud ring 203 which are described above. The inner ring 201 is integrally formed using a single member. As shown in FIG. 5, an outer peripheral surface (inner ring outer peripheral surface 201A) of the inner ring 201 is in contact with the inner shroud ring inner peripheral surface 203B in a state where both of these are flush with each other. The inner ring outer peripheral surface 201A is installed in a state where a slight clearance is formed with the inner peripheral end portion 222T of the nozzle main body 22. Although details will be described later, the inner ring 201 is fixed to the inner shroud ring 203 by means of interference-fitting. The dimension (thickness) of the inner shroud ring 203 in the radial direction is set so that the inner shroud ring 203 can be bent. The dimension of the inner shroud ring 203 in the radial direction indicates the dimension in the radial direction from the inner shroud ring inner peripheral surface 203B to an outer peripheral surface (inner shroud ring outer peripheral surface 203A) of the inner shroud ring 203.

As shown by a broken line in FIG. 5, the outer welded portion 206 is formed between the outer ring 204 and the outer shroud 221. The outer welded portion 206 is formed in a boundary between an end surface (outer ring end surface 204S) of the outer ring 204 facing the axial direction Da and an end surface (outer shroud end surface 221S) of the outer shroud 221 facing the axial direction Da. The outer welded portion 206 is continuously formed in the circumferential direction. Furthermore, the outer welded portion 206 spreads inward in the axial direction Da of the outer ring end surface 204S and the outer shroud end surface 221S from the boundary. That is, the outer welded portion 206 joins the outer ring 204 and the outer shroud 221 to each other. The outer welded portion 206 is formed by means of electronic beam welding.

As similarly shown by a broken line in FIG. 5, the inner welded portion 205 is formed between the inner ring 201 and the inner shroud ring 203, and between the inner ring 201 and the nozzle main body 22 (inner peripheral end portion 222T). The inner welded portion 205 is formed in a boundary between an end surface (inner ring end surface 201S) of the inner ring 201 facing the axial direction Da and an end surface (inner shroud ring end surface 203S) of the inner shroud ring 203 facing the axial direction Da. The inner welded portion 205 is continuously formed in the circumferential direction. Furthermore, the inner welded portion 205 spreads inward in the axial direction Da of the inner ring end surface 201S and the inner shroud ring end surface 203S from the boundary. In particular, the inner welded portion 205 reaches a region between the inner ring outer peripheral surface 201A and the inner peripheral end portion 222T of the nozzle main body 22 (that is, a region where the inner ring outer peripheral surface 201A inside the through-hole 203H and the inner peripheral end portion 222T face each other). That is, the inner welded portion 205 simultaneously joins the inner ring 201, the inner shroud ring 203, and the nozzle main body 22. The inner welded portion 205 is formed by means of electronic beam welding, similarly to the outer welded portion 206.

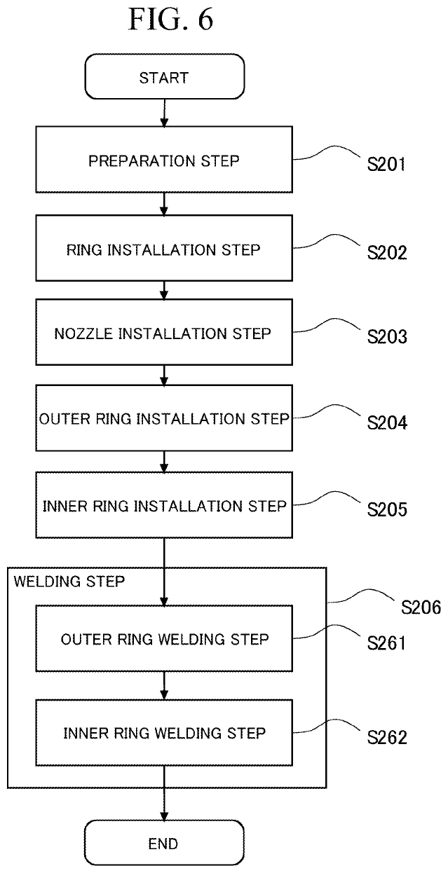

Next, a method for manufacturing the nozzle diaphragm 200 according to the present embodiment will be described with reference to FIG. 6. As shown in the drawing, the manufacturing method includes a preparation step S201, a ring installation step S202, a nozzle installation step S203, an outer ring installation step S204, an inner ring installation step S205, and a welding step S206.

In the preparation step S201, the inner ring 201, the nozzle 202, the inner shroud ring 203, and the outer ring 204 which are described above are prepared.

After the preparation step S201, the ring installation step S202 is performed. In the ring installation step S202, the inner shroud ring 203 is installed on a surface plate so as to form an annular shape. It is desirable that the respective steps subsequent to the ring installation step S202 are performed on the surface plate subjected to leveling and flattening.

After the ring installation step S202, the nozzle installation step S203 is performed. In the nozzle installation step S203, while the inner peripheral end portion 222T of the nozzle main body 22 is inserted into the through-hole 203H of the inner shroud ring 203, the plurality of nozzles 202 are arranged so that the outer shrouds 221 are aligned with each other.

After the nozzle installation step S203, the outer ring installation step S204 is performed. In the outer ring installation step S204, the inner peripheral surface (outer ring inner peripheral surface 204B) of the outer ring 204 is installed along the outer shroud 221. Specifically, the above-described outer ring pieces 204P are arranged in the circumferential direction in a state of being in contact with the outer ring inner peripheral surface 204B, and the adjacent outer ring pieces 204P are joined to each other by means of welding. In this manner, the outer ring 204 having an annular shape is formed. Therefore, the outer ring 204 and the inner shroud ring 203 are installed to be concentric with each other on the surface plate. That is, the inner shroud ring 203 is installed on the inner peripheral side of the outer ring 204.

After the outer ring installation step S204, the inner ring installation step S205 is performed. In the inner ring installation step S205, the inner ring 201 is attached to the inner side of the inner shroud ring 203. More specifically, the inner ring 201 is attached to the inner side of the inner shroud ring 203 by means of cold-fitting. That is, prior to the inner ring installation step S205, the inner ring 201 is installed on the inner side of the inner shroud ring 203 in a state where the inner ring 201 is cooled and thermally contracted. Thereafter, the inner ring 201 is expanded by restoring a normal temperature, and the inner ring 201 is fixed to the inner shroud ring 203 and the inner peripheral end portion 222T of the nozzle main body 22.

After the inner ring installation step S205, the welding step S206 is performed. The welding step S206 includes an outer ring welding step S261 and an inner ring welding step S262. In the outer ring welding step S261, the outer welded portion 206 is formed by means of electronic beam welding. In the inner ring welding step S262, the inner welded portion 205 is formed by means of electronic beam welding. According to the above-described method, all steps of the method for manufacturing the nozzle diaphragm 200 according to the second embodiment are completed.

According to the above-described method and configuration, in the nozzle installation step S203, the nozzle 202 is installed while the inner peripheral end portion 222T of the nozzle main body 22 is inserted into the through-hole 203H formed in the inner shroud ring 203. Here, the inner peripheral end portion 222T of the nozzle main body 22 is attached to the through-hole 203H by means of clearance-fitting. Therefore, in the nozzle installation step S203, even in a state where the inner peripheral end portion 222T is inserted into the through-hole 203H, a posture of the nozzle 202 can be slightly adjusted. Therefore, for example, even in a case where a manufacturing error (dimensional error) occurs between the plurality of nozzles 202, the error can be absorbed by adjusting the posture of the nozzle 202 as described above. Furthermore, it is possible to absorb a strain caused by residual stress between the outer ring 204 and the outer shroud 221, which is generated when the subsequent outer ring installation step S204 is performed, or a strain caused by residual stress between the inner ring 201 and the nozzle main body 22, which is generated when the inner ring installation step S205 is performed. The subsequent welding step S206 is performed in a state where the posture is adjusted in this way. In this manner, it is possible to form the nozzle diaphragm 200 in which each nozzle 202 is located at a correct position and adopts a correct posture.

Furthermore, in the welding step S206, in addition to a region between the inner ring 201 and the inner shroud ring 203, the welding is also performed in a region between the inner peripheral end portion 222T of the nozzle main body 22 and the inner ring 201 (that is, a region inside the through-hole 203H). Therefore, the nozzle main body 22 supported inside the through-hole 203H by means of clearance-fitting can firmly be fixed to the inner ring 201. In this manner, it is possible to form the nozzle diaphragm 200 in which each nozzle 202 is located at a correct position and adopts a correct posture.

In addition, the inner ring 201 can be more firmly fixed to the inner shroud ring 203 by means of cold-fitting. Furthermore, even in a case where the inner peripheral end portion 222T of the nozzle main body 22 protrudes outward in the radial direction from the through-hole 203H formed in the inner shroud ring 203, the inner ring 201 is subjected to the cold-fitting. In this manner, the nozzles 202 can be more uniformly arranged.

### Other Modification Examples of Embodiments

While preferred embodiments of the disclosure have been described and shown above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

In addition, the present disclosure is not limited by the embodiments, and is limited only by the appended claims.

For example, in the first embodiment, an example has been described in which the inner ring 1 is formed using the plurality of inner ring pieces 1P. However, even in a case where the outer shroud ring 3 is used, the inner ring 1 is integrally formed, and the outer ring 4 can also be formed by connecting the plurality of outer ring pieces 204P to each other. Similarly, in the second embodiment, an example has been described in which the outer ring 204 is formed using the plurality of outer ring pieces 204P. However, even in a case where the inner shroud ring 203 is used, the outer ring 204 is integrally formed, and the inner ring 201 can also be formed by connecting the plurality of inner ring pieces 1P to each other, similarly to the above-described first embodiment.

### EXPLANATION OF REFERENCES

1: inner ring
1A: inner ring outer peripheral surface
1P: inner ring piece
1S: inner ring end surface
2: nozzle
3: outer shroud ring
3A: outer shroud ring outer peripheral surface
3H: through-hole
3S: outer shroud ring end surface
4: outer ring
4B: outer ring inner peripheral surface
4S: outer ring end surface
5: inner welded portion
6: outer welded portion
21: inner shroud
21A: inner shroud inner peripheral surface
21B: inner shroud outer peripheral surface
21S: inner shroud end surface
22: nozzle main body
100: nozzle diaphragm
200: nozzle diaphragm
201: inner ring
202: nozzle
203: inner shroud ring
204: outer ring
205: inner welded portion
206: outer welded portion
221: outer shroud
201A: inner ring outer peripheral surface
201S: inner ring end surface
203B: inner shroud ring inner peripheral surface
203H: through-hole
203S: inner shroud ring end surface
204B: outer ring inner peripheral surface
204P: outer ring piece
204S: outer ring end surface
221A: outer shroud outer peripheral surface
221S: outer shroud end surface
222T: inner peripheral end portion
22T: outer peripheral end portion
Da: axial direction
S1: preparation step
S2: ring installation step
S3: nozzle installation step
S4: inner ring installation step
S5: outer ring installation step
S6: welding step
S61: outer ring welding step
S62: inner ring welding step
S201: preparation step
S202: ring installation step
S203: nozzle installation step
S204: outer ring installation step
S205: inner ring installation step
S206: welding step
S261: outer ring welding step
S262: inner ring welding step

What is claimed is:

1. A method for manufacturing a nozzle diaphragm, comprising:
a preparation step of preparing
an inner ring having an annular shape,
a plurality of nozzles each having an inner shroud which comes into contact with an outer peripheral surface of the inner ring, and a nozzle main body having an integral structure which protrudes outward from the inner shroud in a radial direction,
an outer shroud ring having a plurality of through-holes penetrating in the radial direction with a size which enables each outer peripheral end portion of the nozzle main bodies to be inserted into each of the plurality of through-holes, and
an outer ring having an annular shape to be installed on an outer peripheral side with respect to the outer shroud ring;
a ring installation step of installing the outer shroud ring;
a nozzle installation step of installing the plurality of nozzles so that the inner shrouds are aligned, while inserting the outer peripheral end portion into each of the plurality of through-holes formed in the outer shroud ring, after the ring installation step;
an inner ring installation step of annularly installing the inner ring so that the outer peripheral surface of the inner ring is installed along the inner shroud, after the nozzle installation step;
an outer ring installation step of installing the outer ring outside the outer shroud ring, after the inner ring installation step; and
a welding step of welding the outer ring and the outer shroud ring to each other, and welding the inner ring and the inner shroud to each other in the circumferential direction.

2. The method for manufacturing a nozzle diaphragm according to claim 1,
wherein in the welding step, the welding is also performed in a region between the outer ring and the outer peripheral end portion inside each of the plurality of through-holes.

3. The method for manufacturing a nozzle diaphragm according to claim 1,
wherein in the outer ring installation step, the outer ring is fixed to the outer shroud ring by means of shrink-fitting.

4. A nozzle diaphragm comprising:
an inner ring having an annular shape;
a plurality of nozzles disposed in a circumferential direction, and each having an inner shroud which comes into contact with an outer peripheral surface of the inner ring, and a nozzle main body having an integral structure which protrudes outward from the inner shroud in a radial direction;
an outer shroud ring having a plurality of through-holes penetrating in the radial direction so that each outer peripheral end portion of the nozzle main bodies is inserted into each of the plurality of through-holes;
an outer ring having an annular shape, and attached to an outer peripheral surface of the outer shroud ring by means of interference-fitting;
an inner welded portion formed between the inner ring and the inner shrouds so as to join the inner ring and the inner shrouds to each other; and
an outer welded portion formed between the outer ring and the outer shroud ring so as to join the outer ring and the outer shroud ring to each other.

5. The nozzle diaphragm according to claim 4,
wherein the outer welded portion extends to between the outer ring and the outer peripheral end portion inside each of the plurality of through-holes.

6. A method for manufacturing a nozzle diaphragm, comprising:
a preparation step of preparing
an outer ring having an annular shape,
a plurality of nozzles each having an outer shroud which comes into contact with an inner peripheral surface of the outer ring, and a nozzle main body having an integral structure which protrudes inward from the outer shroud in a radial direction,
an inner shroud ring having a plurality of through-holes penetrating in the radial direction with a size which enables each inner peripheral end portion of the nozzle main bodies to be inserted into each of the plurality of through-holes, and
an inner ring having an annular shape to be installed on an outer peripheral side with respect to the inner shroud ring;
a ring installation step of installing the inner shroud ring;
a nozzle installation step of installing the plurality of nozzles so that the outer shrouds are aligned, while inserting the inner peripheral end portion into each of the plurality of through-holes formed in the inner shroud ring, after the ring installation step;
an outer ring installation step of annularly installing the outer ring so that the inner peripheral surface of the outer ring is installed along the outer shroud, after the nozzle installation step;
an inner ring installation step of installing the inner ring inside the inner shroud ring, after the outer ring installation step; and
a welding step of welding the inner ring and the inner shroud ring to each other, and welding the outer ring and the outer shroud to each other in the circumferential direction.

7. The method for manufacturing a nozzle diaphragm according to claim 6,
wherein in the welding step, the welding is also performed in a region between the inner ring and the inner peripheral end portion inside each of the plurality of through-holes.

8. The method for manufacturing a nozzle diaphragm according to claim 6,
wherein in the inner ring installation step, the inner ring is fixed to the inner shroud ring by means of cold-fitting.

9. A nozzle diaphragm comprising:
an outer ring having an annular shape;
a plurality of nozzles disposed in a circumferential direction, and each having an outer shroud which comes into contact with an inner peripheral surface of the outer ring, and a nozzle main body having an integral structure which protrudes inward from the outer shroud in a radial direction;
an inner shroud ring having a plurality of through-holes penetrating in the radial direction so that each inner peripheral end portion of the nozzle main bodies is inserted into each of the plurality of through-holes;
an inner ring having an annular shape, and attached to an inner peripheral surface of the inner shroud ring by means of interference-fitting;
an outer welded portion formed between the outer ring and the outer shrouds so as to join the outer ring and the outer shrouds to each other; and
an inner welded portion formed between the inner ring and the inner shroud ring so as to join the inner ring and the inner shroud ring to each other.

10. The nozzle diaphragm according to claim 9,
wherein the inner welded portion extends to between the inner ring and the inner peripheral end portion inside each of the plurality of through-holes.
